(19) United States
(12) Patent Application Publication
(10) Pub. No.: US 2004/0211511 A1
(43) Pub. Date: Oct. 28, 2004

(54) Joining method

(76) Inventor: Shinji Suzuki, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/829,225

(22) Filed: Apr. 22, 2004

(30) Foreign Application Priority Data
Apr. 23, 2003 (JP) 2003-118001

(51) Int. Cl. B32B 31/28; C03B 8/00

(52) U.S. Cl. 156/273.3; 156/272.2; 65/17.2; 156/308.2

(57) ABSTRACT

In a method for joining a joined material having a hydroxyl group containing surface to a joining material having an organosiloxay group containing surface, the organosiloxay group containing surface is irradiated by ultraviolet radiation having wavelength of less than 220 nm thereby carrying out an oxidization treatment, and the hydroxyl group containing surface is adhered to the oxidized organosiloxay group containing surface.

### TECHNICAL FIELD OF THE INVENTION

The present invention relates to a method for joining two members, and more specifically, to a joining method which is suitably used in a process for producing a microreactor.

### DESCRIPTION OF RELATED ART

In the biological chemistry field, a method of performing separation, synthesis, extraction, analysis etc. of a minute amount of reagent etc. by using a microreactor comprising a microchip(s) in which a channel(s) for micro-scale analysis is formed by the art of a micro fabrication for semiconductor on a small substrate which is made of, for example, silicone, silicon, glass, etc., has gotten a lot of attention recently.

A reaction analysis system using such a microreactor is called a “micro total analysis system” (hereinafter referred to as “μTAS”). In such a μTAS, it is possible to perform high-speed and highly precise reaction analysis since a ratio of the surface area of a reagent to the volume becomes large and, it is possible to realize a compact and automated system.

In practice, although, for example, the conventional reaction analysis system requires several hours to over ten hours in order to perform reaction analysis, in the μTAS, the same reaction analysis is performed in a short time, such as, several minutes to dozen minutes

For example, such a microreactor comprises a first substrate on which a injection port, a discharge port and a channel(s) for connecting these ports are formed, and a transparent substrate which is laminated and joined on the first substrate so as to seal the injection port, the discharge port and the channel formed on the first substrate, wherein a reagent is supplied to the injection port through a through hole for injecting a reagent, the supplied reagent passes through the channel which is a reaction path, and is finally, discharged through a through hole for discharging a reagent which is formed in the discharge port.

Generally, in order to join two substrates, adhesive is used, but in the microreactor, when the adhesive is used for junction of the substrates, there is a problem that there is a possibility that the adhesive badly influences the reaction system to be analyzed.

Accordingly, for example, as a method for joining two substrates of a microreactor, in case that, a silicon substrate and a glass substrate are used as these two substrates, an anode joining method for joining these two substrates by impressing voltage between these two substrates while they are heated to a temperature of 300 to 500 degrees Celsius, has been proposed. For example, refer to Japanese Laid Open Patent No. 10-337173.

In case that a polydimethylsiloxane substrate and a glass substrate are used as these substrates, a method for joining these two substrates by using self-joining nature to a flat surface, which polydimethylsiloxane of the polydimethylsiloxane substrate has, has been proposed. For example, refer to Japanese Laid Open Patent No. 2002-85961.

However, in the anode joining method, there is a problem that a large size apparatus for impressing voltage to two substrates while heating them is necessary.

In the method using the self-joining nature, since the adhesive strength between these jointed substrates is small, the microreactor produced by using this method may have a problem that, when pressure is applied to the microreactor by a pump in order to inject the reagent into the injection port, the sealed state cannot be maintained during the reaction analysis process due to a gap created on the joint surface by the pressure.

### SUMMARY OF THE INVENTION

In view of the above problems, the present invention is to provide a joining method capable of easily joining two members firmly without using adhesives.

A method for joining a joined material having a hydroxyl group containing surface to a joining material having an organosiloxay group containing surface, wherein the organosiloxay group containing surface is irradiated by ultraviolet radiation having wavelength of less than 220 nm thereby carrying out an oxidization treatment, and the hydroxyl group containing surface is adhered to the oxidized organosiloxay group containing surface.

The joined material may be made of glass.

The organosiloxay group containing surface may be formed by a surface altering treatment using hexamethyldisilazane.

According to the joining method of this invention, an oxidation treatment to a hydrophobic surface is carried out by irradiating ultraviolet radiation with specific wavelength on the hydrophobic surface of a junction base material, on which the organosiloxay group exists.

Since the surface of the joining base material and the surface of a material to be joined (hereinafter referred to as a “joined material”) are joined based on the large chemical binding action of binding energy by making stick together the surface on which the oxidation treatment is carried out and the hydroxyl group containing hydrophilic surface of the jointing material, it is possible to easily join the joining base material and the joined material and firmly without adhesives and a large size and expensive apparatus.

The present invention will become more apparent from the following detailed description of the embodiments and examples of the present invention.

### DESCRIPTION OF THE DRAWINGS

FIG. 1 is a schematic view wherein the state of the surface of joining material is shown;

FIG. 2 is a diagram showing a state where radiation light from a light source is emitted onto a hydrophobic surface of the joining material;

FIG. 3 is a schematic view showing a state of the surface of a joined material on which an oxidized surface of the joining material is laminated;

FIG. 4 is a schematic view showing a state in which the surface of the joining material and the surface of the joined material are joined;

FIG. 5 is a schematic view showing another state in which the surface of the joining material and the surface of the joined material are joined;

FIG. 6 is a schematic view a state of the surface of silicon containing material made of silicon wafer;

FIG. 7 is a schematic view showing a state of the surface of a substrate produced by carrying out a surface altering treatment to the silicon containing material shown in FIG. 6; and

FIG. 8 is a schematic view showing a state of the oxidized surface of the substrate.

### DETAILED DESCRIPTION OF THE INVENTION

The present invention will be described below in detail.

A joining method according to the present invention is a method for joining two members, and especially, a method for joining a surface of joining material which contains a hydroxyl group (hereinafter referred to as a “hydrophilic surface” to a surface of the joining base material which contains an organosiloxay (group) (hereinafter referred to as “a hydrophobic surface”). In the method, the hydrophobic surface of the joining base material is irradiated by ultraviolet ray of less than 220 nm wavelength thereby carrying out oxidation treatment, and then the hydrophilic surface of the joined material is made in close contact with the surface on which the oxidation treatment is carried out.

As the joining base material, silicone such as polydimethylsiloxane is suitably used. On the other hand, as the jointed material, glass is used suitably.

An example in which a substrate made of a polydimethylsiloxane resin (hereinafter referred to as a “polysiloxane substrate”) expressed in the following Formula 1 as the joining base material and a substrate made of glass (hereinafter referred as a “glass substrate”) as the joined material are used is described below in detail.

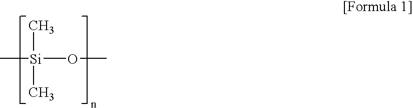

The “n” in the Formula 1 shows the number of repetitions.

First, for example, a glass substrate 20 (joined material) having a thickness of 1.1 mm, which is matched up with the size of a polysiloxane substrate 10 (joining base material) having a thickness of 2 mm, are prepared.

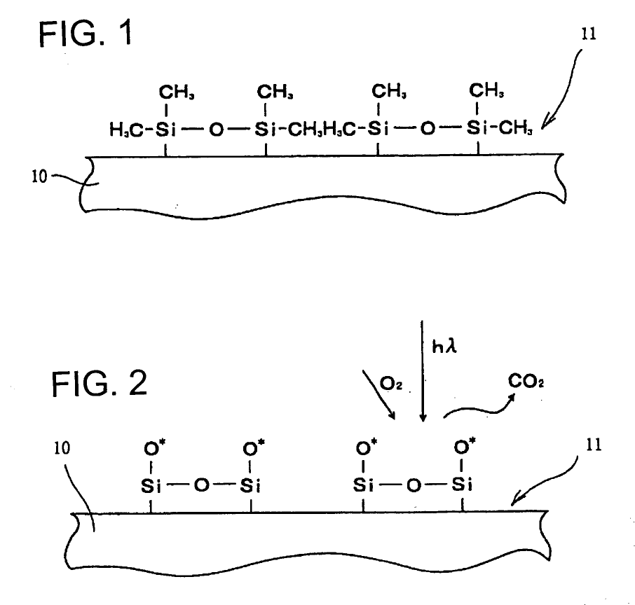

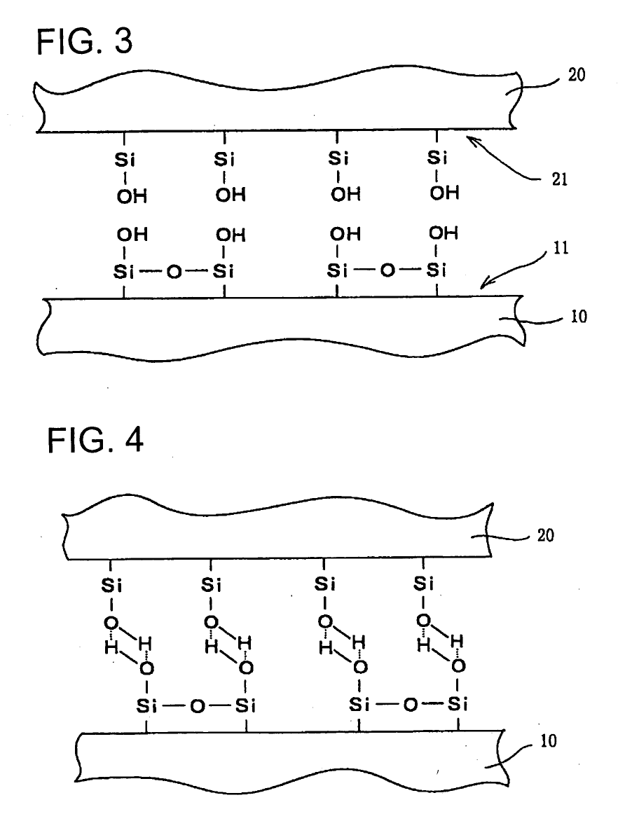

As shown in FIG. 1, the polysiloxane substrate 10 has the hydrophobic surface (on an upper surface in FIG. 1) in the state where the organosiloxay (group) exists, and as shown in FIG. 3, the glass substrate 20 has the hydrophilic surface (on the undersurface shown in FIG. 3) in the state where the hydroxyl group exists.

As shown in FIG. 2, an excimer lamp (not shown) which has an emission line, for example, in wavelength 172 nm is disposed as a light source above the surface 11 which is the hydrophobic surface of the polysiloxane substrate 10 (on the upper side of FIG. 2). In the atmosphere containing ozone or oxygen, radiation light from the light source is irradiated on the surface 11 entirely for 100 seconds under a condition that the intensity of the radiation light is, for example, 10 mW/cm³, so that the amount of radiation is 1,000 mJ/m².

Oxygen or ozone mainly acts with the ultraviolet radiation emitted from the light source in such a UV irradiation treatment, so that active oxygen is generated.

When the active oxygen contacts the surface 11 of the polysiloxane substrate 10, the surface 11 is oxidized so that methyl group related to the organosiloxay (group) is desorbed on the surface 11, and the silicon atom to which the methyl group was joined is joined with the active oxygen.

Thus, the oxidation treatment of the surface 11 of the polysiloxane substrate 10 is entirely carried out on the whole surface.

In this example, the UV irradiation treatment is performed in the air, and since moisture may exist in the atmosphere of the treatment and a hydrogen atom may be combined with active oxygen, the surface 11 of the polysiloxane substrate 10 is in the state (refer to FIG. 3) where the hydroxyl group was combined with the silicon atom.

Subsequently, as shown in FIG. 3, the surface 21 which is a hydrophilic surface of a glass substrate 20 is laminated on the surface 11 of the polysiloxane substrate 10. By maintaining the state, for example, for tens of seconds, the surface 11 of the polysiloxane substrate 10, and the surface 21 of a glass substrate 20 are made in close contact with each other, as shown in FIG. 4, so that a hydrogen bond is formed in the interface of the surface 11 and the surface 21.

Thus, when the surface 11 of the polysiloxane substrate 10 and the surface 21 of the glass substrate 20 are joined together by the action of a hydrogen bond, so that the polysiloxane substrate 10 and the glass substrate 20 are joined with high bond strength.

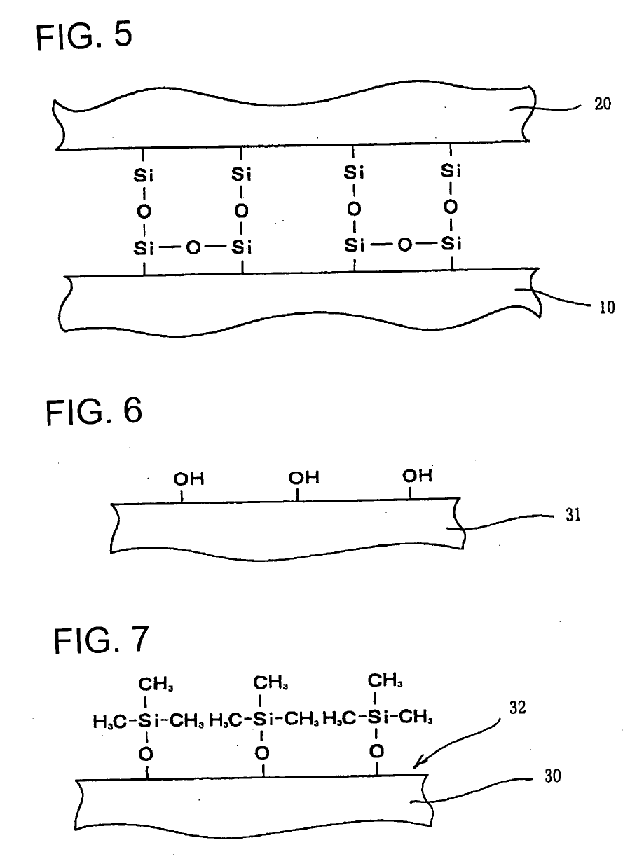

In case that the UV irradiation treatment and adhesion treatment are carried out, for example, in the atmosphere in which the moisture does not exist, such as in dry air (for example, air whose dew point is below −50 degrees Celsius), pure oxygen gas or dinitrogen monoxide gas (laugher gas), since the surface 11 of the polysiloxane substrate 10 is made in close contact with the surface 21 of the glass substrate 20 in the state where an oxygen atom exists, and as shown in FIG. 5, a covalent bond is formed in the interface of the surface 11 of the polysiloxane substrate 10, and the surface 21 of a glass substrate 20 so that the surface 11 of the polysiloxane substrate 10 and the surface 21 of the glass substrate 20 are joined, thereby joining the polysiloxane substrate 10 and the glass substrate 20.

Since the bond energy of the covalent bond is larger than that of a hydrogen bond, the bond strength of the polysiloxane substrate 10 and glass substrate 20 which are joined are further higher.

As the polysiloxane substrate 10, a sheet body may be used, which is obtained, for example, by mixing a polydimethylsiloxane prepolymer and a curing agent in the proportion of 10 to 1, stirring and vacuum-degassing them thereby preparing prepolymer mixed liquor, carrying out a curing treatment in which the prepolymer mixed liquor is poured on a master whose shape corresponds to the shape necessary for the polysiloxane substrate 10, thereby acquiring a polydimethylsiloxane layer, and peeling off the polydimethylsiloxane layer from the master.

A light source which irradiates ultraviolet radiation with less than 220 nm wavelength may be used in the present invention.

By irradiating the ultraviolet radiation with less than 220 nm wavelength, in the atmosphere containing oxygen or ozone, active oxygen can be generated and the surface 11 of polysiloxane substrate 10 can be oxidized.

In addition, a light source which irradiates ultraviolet radiation with less than 200 nm wavelength is preferably used. Since the amount of active oxygen which can be generated per time becomes large by irradiating ultraviolet radiation with 200 nm wavelength, it is possible to reduce time required for carrying out the UV irradiation treatment.

An excimer lamp, a low-pressure mercury lamp, a deuterium lamp, etc. can be used as a light source. The excimer lamp described above which has an emission line around wavelength 172 nm, the low-pressure mercury lamp which has an emission line around wavelength 185 nm or the deuterium lamp which has an emission line around wavelength 120 to 200 nm can be suitably used as a light source.

It is preferred to perform the adhesion treatment within 20 seconds after the UV irradiation treatment. It is possible to certainly acquire high bond strength in the joint of the polysiloxane substrate 10 and glass substrate 20 by carrying out the adhesion treatment immediately after the UV irradiation treatment ends.

According to the above joining methods, the ultraviolet radiation having a certain wavelength is irradiated onto the surface 11 of the polysiloxane substrate 10 thereby carrying out an oxidation treatment of the surface 11, and then the oxidized surface 11 and the surface 21 of the glass substrate 20 are made stick together so that the surface 11 of the polysiloxane substrate 10 and the surface 21 of the glass substrate 20 are joined by the action of the hydrogen bond or a covalent bond, either of which has large bond energy.

Since the series of processes can be suitably performed at an ordinary temperature under an ordinary pressure, it is possible to easily join the polysiloxane substrate 10 and the glass substrate 20 firmly without using adhesives and a large expensive apparatus.

In practice, the bond strength of the polysiloxane substrate 10 and the glass substrate 20 which are joined becomes larger than the bulk hardness of the polysiloxane substrate 10.

A polysiloxane substrate sample and a glass substrate sample which the shape has applied to the polysiloxane substrate sample are prepared. Under the above-mentioned conditions, after ultraviolet radiation in the air is irradiated to part of the polysiloxane substrate sample which is located approximately at the center of the whole surface of the sample, the glass substrate sample is affixed to the whole surface of the polysiloxane substrate, thereby acquiring a laminated body in which these two samples are joined at their center.

When the bond strength measurement test in which both ends of the polysiloxane substrate sample of the laminated body are pulled in the outside direction perpendicular to the glass substrate sample was performed, the polysiloxane substrate sample was damaged, but exfoliation thereof did not arise in part for the joint portion.

Although the joining method according to the invention is explained above using the examples, the present invention is not limited to these examples described above as long as ultraviolet radiation with a certain wavelength is irradiated on the hydrophobic surface of a joining base material thereby carrying out oxidation treatment and the hydrophilic surface of the joined material is adhered to the oxidized surface.

For example, in the joining method, as the joining material, a substrate may be prepared by exposing a surface (such as an upper surface shown in FIG. 6) of silicon atom containing material 31 made of material containing silicon such as silicon wafer, to vapor of hexamethyldisilazane (HMDS) expressed in Formula (2) thereby altering a state of the surface so that the organosiloxay (group) as shown in FIG. 7 exists in order to form a hydrophobic surface.

[Formula 2]

(CH₃)Si—NH—Si(CH₃)

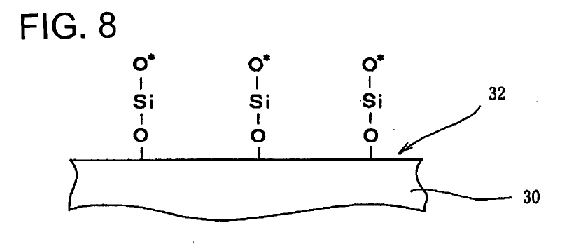

Even where the substrate 30 having the surface 32 on which the surface alternating treatment is performed by hexamethyldisilazane is used as a joining base material, in the atmosphere containing oxygen or ozone, the methyl group concerning an organosiloxay group as shown in FIG. 8 is disorped so that active oxygen is combined with the silicon atom with which the methyl group was combined, by irradiating ultraviolet radiation with a wavelength of 220 nm or less to the surface 32 which is the hydrophobic surface thereby carrying out oxidation treatment.

And the surface 32 of the substrate 30 is joined to the hydrophilic surface of the joined material, thereby joining the substrate 30 which is the joining base material and the joined material by action of a hydrogen band or a covalent bond.

According to the present invention, since two members can be joined without using adhesives, the joining method can be also suitably used in the process for producing a microreactor.

Specifically, in the joining method according to the invention, for example, an injection port which has a through hole for reagent injection, a discharge port having a through hole for discharging reagent, and a recess, such as a channel which connects these ports, are formed on a substrate made of, for example, silicone resin (hereinafter referred to as a “silicone substrate.”) in a certain position by an etching method.

In the atmosphere at an ordinary temperature under ordinary pressure, ultraviolet radiation having less than 220 nm wavelength is irradiated on the entire surface thereby oxidizing it, and subsequently, a glass substrate is made in close contact with the surface on which oxidation treatment has been carried out so as to cover the oxidized surface. Thus, by the glass substrate, without using adhesives it is possible to produce a microreactor in the state where the recesses formed on the silicone substrate are sealed by the simple method described above.

Thus, since in the produced microreactor, the bond strength of the silicone substrate and the glass substrate which were joined, is large, it is possible to eliminate the harmful effect during a series of reaction analysis processes, in which a reagent is supplied into the injection port through a through hole for injecting a reagent formed on the injection port by pressure of a pump, passes through the channel which is a reaction path, and is finally discharged from the discharge port through a through hole for discharging reagent formed on the discharge port.

It is possible to apply the joining method according to the present invention to the junction of building materials. For example, since solvent used for adhesives is regarded as the cause of sick house syndrome, there is an advantage that the development of the sick house syndrome resulting from adhesives can be prevented.

According to the joining method of the present invention, the oxidation treatment of the hydrophobic surface is carried out by irradiating the ultraviolet radiation having a specific wavelength on the hydrophobic surface on which the organosiloxay group in a junction base material exists, and the adhering process is carried out by adhering the hydrophilic surface of the jointing material, where the hydroxyl group exists, to the oxidized surface, thereby joining the surface of the joining base material and the surface of the joined material by the action of chemical band whose band energy is large, so that it is possible to join them easily and firmly without a large and expensive apparatus.

Thus the present invention possesses a number of advantages or purposes, and there is no requirement that every claim directed to that invention be limited to encompass all of them.

The disclosure of Japanese Patent Application No. 2003-118001 filed on Apr. 23, 2003 including specification, drawings and claims is incorporated herein by reference in its entirety.

Although only some exemplary embodiments of this invention have been described in detail above, those skilled in the art will readily appreciated that many modifications are possible in the exemplary embodiments without materially departing from the novel teachings and advantages of this invention. Accordingly, all such modifications are intended to be included within the scope of this invention.

What is claimed is:

1. A method for joining a joined material having a hydroxyl group containing surface to a joining material having an organosiloxay group containing surface, wherein the organosiloxay group containing surface is irradiated by ultraviolet radiation having wavelength of less than 220 nm thereby carrying out an oxidization treatment, and the hydroxyl group containing surface is adhered to the oxidized organosiloxay group containing surface.

2. The method according to claim 1, wherein the joined material is made of glass.

3. The method according to claim 1, wherein the organosiloxay group containing surface is formed by a surface altering treatment using hexamethyldisilazane.
